(19) United States
(12) Patent Application Publication
(10) Pub. No.: US 2022/0215509 A1
(43) Pub. Date: Jul. 7, 2022

(54) PHYSICS-BASED RECOVERY OF LOST COLORS IN UNDERWATER AND ATMOSPHERIC IMAGES UNDER WAVELENGTH DEPENDENT ABSORPTION AND SCATTERING

(71) Applicants: CARMEL HAIFA UNIVERSITY ECONOMIC CORPORATION LTD., Haifa (IL); SEAERRA VISION LTD., Haifa (IL)

(72) Inventors: Derya AKKAYNAK, Eilat (IL); Avital TREIBITZ, Beer Yaacov (IL)

(21) Appl. No.: 17/613,229

(22) PCT Filed: May 21, 2020
(86) PCT No.: PCT/IL2020/050563

§ 371 Date: Nov. 22, 2021

Related U.S. Application Data
(60) Provisional application No. 62/850,752, filed on May 21, 2019.

(51) Int. Cl. G06T 5/00; G06T 7/90

(52) U.S. Cl. CPC G06T 5/001; G06T 2207/10028; G06T 2207/10024; G06T 7/90

(57) ABSTRACT

A method comprising: receiving an input image, wherein the input image depicts a scene within a medium which has wavelength-dependent absorption and/or scattering; estimating, based, at least in part, on a range map of the scene, one or more image formation model parameters; and recovering the scene from the input image, based, at least in part, on the estimating.

### CROSS-REFERENCE TO RELATED APPLICATIONS

This application claims the benefit of priority to U.S. Provisional Patent Application No. 62/850,752, filed May 21, 2019, the contents of which are incorporated herein by reference in their entirety.

### BACKGROUND

Large image datasets like ImageNet have been instrumental in igniting the artificial intelligence boom, which fueled many important discoveries in science and industry in the last two decades. The underwater domain, which has no shortage of large image datasets, however, has not benefited from the full power of computer vision and machine learning methods which made these discoveries possible, partly because water masks many computationally valuable features of a scene.

An underwater photo is the equivalent of one taken in air, but covered in thick, colored fog, and subject to an illuminant whose white point and intensity changes as a function of distance. It is difficult to train learning-based methods for different optical conditions that represent the global ocean, because calibrated underwater datasets are expensive and logistically difficult to acquire.

Existing methods that attempt to reverse the degradation due to water are either unstable, too sensitive, or only work for short object ranges. Thus, the analysis of large underwater datasets often requires costly manual effort. On average, a human expert spends over 2 hours identifying and counting fish in a video that is one hour long.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive an input image, wherein the input image depicts a scene within a medium which has wavelength-dependent absorption and/or scattering, estimate, based, at least in part, on a range map of the scene, one or more image formation model parameters, and recover the scene from the input image, based, at least in part, on the estimating.

There is provided, in an embodiment, a method comprising receiving an input image, wherein the input image depicts a scene within a medium which has wavelength-dependent absorption and/or scattering; estimating, based, at least in part, on a range map of the scene, one or more image formation model parameters; and recovering the scene from the input image, based, at least in part, on the estimating.

There is provided, in an embodiment, a computer program product comprising a non-transitory computer-readable storage medium having program instructions embodied therewith, the program instructions executable by at least one hardware processor to: receive an input image, wherein the input image depicts a scene within a medium which has wavelength-dependent absorption and/or scattering; estimate, based, at least in part, on a range map of the scene, one or more image formation model parameters; and recover the scene from the input image, based, at least in part, on the estimating.

In some embodiments, the image is selected from the group consisting of grayscale image, RGB image, RGB-Depth (RGBD) image, multi-spectral image, and hyperspectral image.

In some embodiments, the medium is one of: water and ambient atmosphere.

In some embodiments, the scene is under water.

In some embodiments, the recovering removes an effect of the wavelength-dependent absorption and/or scattering medium from the input image.

In some embodiments, the image formation model parameters include at least one of: backscatter parameters in the input image, and attenuation parameters in the input image.

In some embodiments, the image formation model parameters are estimated separately with respect to each color channel in the input image.

In some embodiments, the estimating of the one or more image formation model parameters is based, at least in part, on distances to each object in the scene, wherein the distances are obtained using the range map.

In some embodiments, the range map is obtained using one of: a structure-from-motion (SFM) range imaging techniques, stereo imaging techniques, and monocular techniques.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1A-1B show is a schematic illustration of a present method for removing water from underwater images, by removing the degradation due to water, according to an embodiment;

FIG. 2 is a schematic illustration of underwater image formation, according to an embodiment;

FIG. 3A is a three-dimensional (3D) model created from 68 photographs, according to an embodiment;

FIG. 3B is a range map for the image in FIG. 3A, according to an embodiment;

FIG. 4A shows a color chart imaged underwater at various ranges;

FIG. 4B shows B_{c} calculation for each color channel, according to an embodiment; and

FIGS. 5A-5D, 6A-6E and 7A-7E show experimental results, according to an embodiment.

### DETAILED DESCRIPTION

Disclosed herein is a method that recovers lost colors in underwater images using a physics-based approach. In some embodiments, the present method estimates the parameters of the image formation model.

In some embodiments, the images may be acquired using a plurality of imaging formats, including grayscale, RGB, RGB-Depth (RGBD), multi-spectral, hyperspectral, and/or additional and/or other imaging techniques.

Robust recovery of lost colors in underwater images remains a challenging problem. This is partly due to the prevalent use of an atmospheric image formation model for underwater images. A recently proposed physically accurate and/or revised model showed:
(i) Attenuation coefficient of the signal is not uniform across the scene but depends on object range and reflectance, and
(ii) the coefficient governing the increase in backscatter with distance differs from the signal attenuation coefficient.

Using more than 1,100 images from two optically different water bodies, the present inventors show that the present method comprising a revised image formation model outperforms those using the atmospheric model. Consistent removal of water will open up large underwater datasets to powerful computer vision and machine learning algorithms, creating exciting opportunities for the future of underwater exploration and conservation.

The present method aims to consistently remove water from underwater images, so that large datasets can be analyzed with increased efficiency. In some embodiments, the present method estimates model parameters for a given RGBD image.

In some embodiments, the present method provides for an image formation model derived for imaging in any medium which has wavelength-dependent absorption and/or scattering. In some embodiments, such medium may be, but is not limited to, water and ambient atmosphere. Accordingly, in some embodiments, the present method provides for deriving an image formation model for underwater imaging, for imaging in fog or haze conditions, and the like.

In some embodiments, the present method parametrizes the distance-dependent attenuation coefficient, which greatly reduces the unknowns in the optimization step.

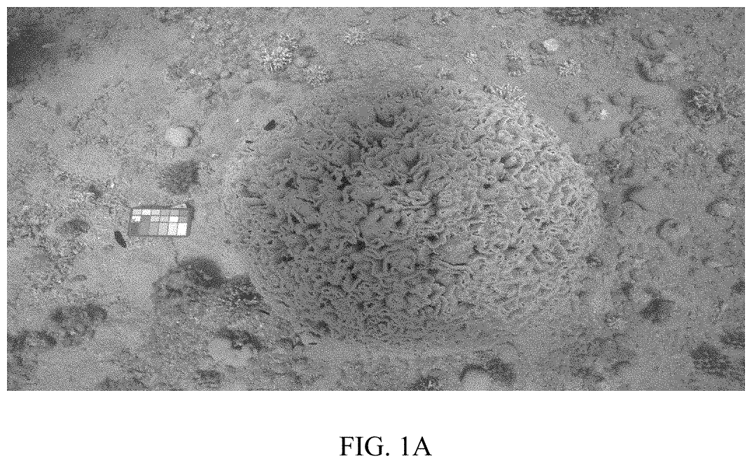

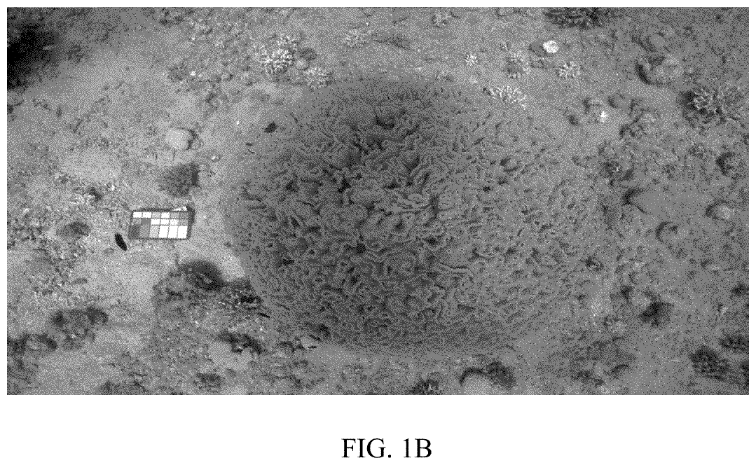

The present inventors have used more than 1,100 images acquired in two optically different water types. On these images and another underwater RGBD dataset, the present inventors show qualitatively and quantitatively that the present method, which is the first to utilize the revised image formation model, outperforms others that use currently known models. Reference is now made to FIG. 1A-1B, which show is a schematic illustration of the present method which removes water from underwater images (FIG. 1A) by removing the degradation due to water (FIG. 1B).

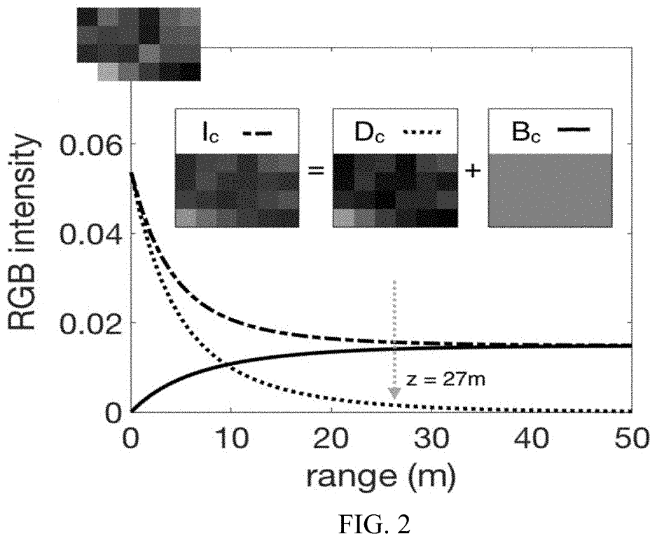

Reference is now made to FIG. 2, which is a schematic illustration of underwater image formation governed by an equation of the form I_{c}=D_{c}+B_{c}. D_{c} contains the scene with attenuated colors, and B_{c} is a degrading signal that strongly depends on the optical properties of the water, and eventually dominates the image (shown in FIG. 2 as a gray patch). Insets show relative magnitudes of D_{c} and B_{c} for a Macbeth chart imaged at 27 m in oceanic water.

A known image formation model for bad weather images assumes that the scattering coefficient is constant over the camera sensitivity range in each color channel, resulting in a coefficient per wavelength. This model then became extensively used for bad weather, and later adapted for the underwater environment. For scene recovery, these methods require more than one frame of the scene, or extra information, such as 3D structure. These models are further simplified to include only one attenuation coefficient, uniform across all color channels. This was done to enable recovery from single images in haze and later used also for underwater recovery. While using the same coefficient for all color channels in underwater scenes is a very crude approximation, using a coefficient per channel may yield better results. Nevertheless, as will be further shown below, the accuracy of these methods is inherently limited by the model.

In previous work, backscatter is estimated from single images using the Dark Channel Prior (DCP) method (see, K. He, J. Sun, and X. Tang. Single image haze removal using dark channel prior. Trans. IEEE PAMI, 33(12):2341-2353, 2011), some variants of it, or other priors. Attenuation coefficients can be measured by ocean optics instruments such as transmissiometers or spectrometers. However, they cannot be used as-is for imaging because of differences in spectral sensitivity and acceptance angle. In addition, these instruments are expensive and cumbersome to deploy.

Thus, it is generally best to estimate the attenuation coefficients directly from images. The most basic method for that is to photograph a calibration target at a known distance. In one method, coefficients were taken from the estimated veiling-light, ignoring the illumination color. In another method, the attenuation coefficients per channel were estimated using the grey-world assumption. Others methods alleviate this problem by using fixed attenuation coefficients measured for just one water type.

Known distances slightly simplify the problem and were used to estimate backscatter together with attenuation by fitting data from multiple images to the image formation model. Deep networks were recently used for reconstructing underwater scenes. Their training, however, relies on purely synthetic data, and thus highly depends on the quality of the simulation models. All the methods so far assume the attenuation coefficients are only properties of the water and are uniform across the scene per color channel, but it has been showed that this is an incorrect assumption that leads to errors in reconstruction.

### Scientific Background

Underwater image formation is governed by:

I_{c}=D_{c}+B_{c} (1)

where c=R, G, B is the color channel, I_{c} is the image captured by the camera (with distorted colors), D_{c} is the direct signal which contains the information about the (attenuated) scene, and B_{c} is the backscatter, an additive signal that degrades the image due to light reflected from particles suspended in the water column. The components D_{c} and B_{c} are governed by two distinct coefficients β_{c}^{D} and β_{c}^{B}, which are wideband (RGB) attenuation and backscatter coefficients, respectively.

The expanded form of Eq. 1 is given as:

I_{c}=J_{c}e^{-β}^{_{c}}^{^{D}}^{(v}^{_{D}}^{)·z}+B_{c}^{∞}(1−e^{-β}^{_{c}}^{^{B}}^{(v}^{_{B}}^{)·z}) (2)

where z is range (distance) between the camera and the objects in the scene along the line of sight, B_{c}^{∞} is veiling light, and J_{c} is the unattenuated scene that would be captured at the location of the camera had there been no attenuation along z. Vectors v_{D}={z, ρ, E, S_{c}, β} and v_{B}={E, S_{c}, b, β} represent the dependencies of the coefficients β_{c}^{D} and β_{c}^{B} on range z, reflectance ρ, spectrum of ambient light E, spectral response of the camera S_{c}, and the physical scattering and beam attenuation coefficients of the water body, b and β, all of which are functions of wavelength λ.

Previously, it was assumed that β_{c}^{D}=β_{c}^{B}, and that these coefficients had a single value for a given scene, but it was previously shown in D. Akkaynak and T. Treibitz [2018] (see, D. Akkaynak and T. Treibitz. A revised underwater image formation model. In Proc. IEEE CVPR, 2018) that they are distinct, and furthermore, that they had dependencies on different factors. Eq. 2 is formulated for imaging in the horizontal direction. However, it may be applied to scenes captured in different directions with the assumption that the deviations are small.

The equations connecting RGB coefficients β_{c}^{D} and β_{c}^{B} to wavelength dependent physical quantities are:

$$\begin{matrix}{β}_{c}^{D} = ln [ \frac{{\int }_{{λ}_{1}}^{{λ}_{2}} {S}_{c} ( λ ) ρ ( λ ) E ( d , λ ) {e}^{- β ( λ ) z} dλ}{{\int }_{{λ}_{1}}^{{λ}_{2}} {S}_{c} ( λ ) ρ ( λ ) E ( d , λ ) {e}^{- β ( λ ) ( z + Δ z )} dλ} ] / Δ z & ( 3 ) \\ {β}_{c}^{B} = - ln [ 1 - \frac{{\int }_{{λ}_{1}}^{{λ}_{2}} {S}_{c} ( λ ) {B}^{∞} ( λ ) ( 1 - {e}^{- β ( λ ) z} ) dλ}{{\int }_{{λ}_{1}}^{{λ}_{2}} {B}^{∞} ( λ ) {S}_{c} ( λ ) dλ} ] / z & ( 4 )\end{matrix}$$

Here, λ₁ and λ₂ are the limits of the visible range (400 and 700 nm), E is the spectrum of ambient light at depth d.

Light penetrating vertically attenuates based on the diffuse downwelling attenuation K_{d}(λ), different than the beam attenuation coefficient β(λ), which is solely a function of the type, composition, and density of dissolved substances in the ocean. If E(0,λ) is light at the sea surface, then E(d,λ) at depth d is:

E(d,λ)=E(0,λ)e^{-K}^{_{d}}^{(λ)d} (5)

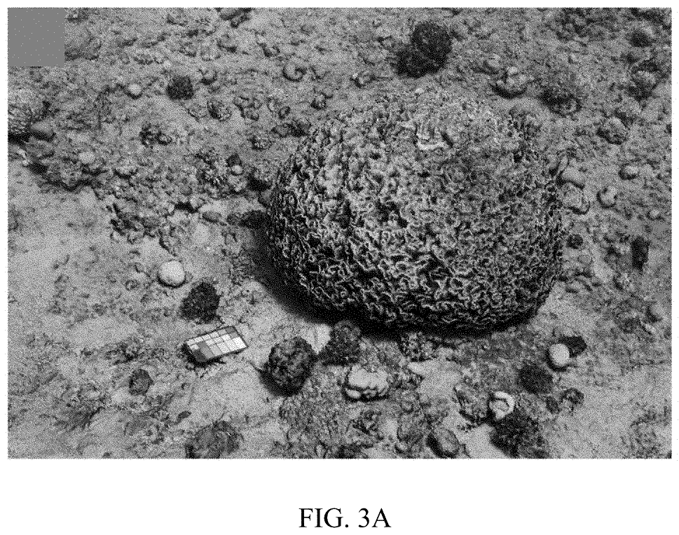

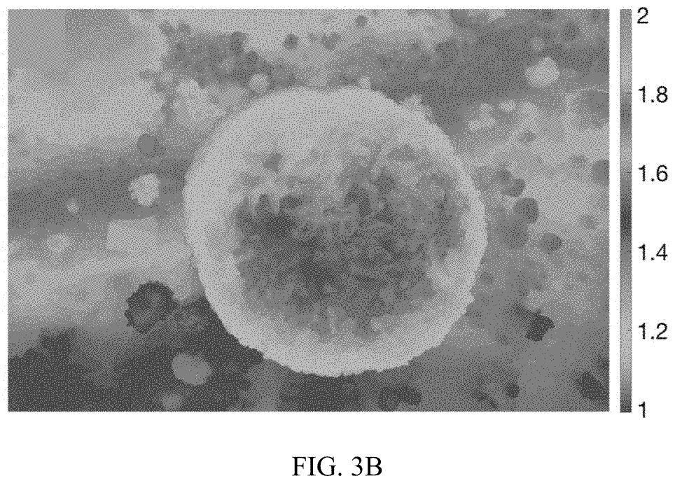

Reference is now made to FIG. 3A, which shows a 3D model created from 68 photographs using Photoscan Professional (Agisoft LLC).

Reference is now made to FIG. 3B, which shows a model range map z (in meters) for the image in FIGS. 1A-1B obtained from this model. A color chart is placed on the seafloor to set the scale.

The veiling light B_{c}^{∞} in Eq. 2 is given as:

B_{c}^{∞}=∫_{λ}_{₁}^{λ}^{₂}S_{c}(λ)B^{∞}(λ)dλ (6)

where

B^{∞}(λ)=[b(λ)E(d,λ)]/β(λ) (7)

### The Present Method

Based on Eqs. 2-4, to recover J_{c}, the following parameters need to be known or estimated:
optical water type determined by b, β, and K_{d};
light E_{d};
distance between the camera and scene along the line-of-sight z;
depth at which the photo was taken d;
the reflectance of each object in the scene ρ; and
the spectral response of the camera S_{c}.

These parameters are rarely, if ever, known at the time an underwater photo is taken.

In D. Akkaynak and T. Treibitz. [2018] and in D. Akkaynak, T. Treibitz, T. Shlesinger, R. Tamir, Y. Loya, and D. Iluz., “What is the space of attenuation coefficients in underwater computer vision?” In Proc. IEEE CVPR, 2017, it was shown that β_{c}^{D} was most strongly governed by z, and β_{c}^{B} was most affected by the optical water type and illumination E. Therefore, in some embodiments, the present method attempts to tackle these specific dependencies. Because the coefficients vary with imaging angle and exposure, it is assumed that they generally cannot be transferred across images, even those taken sequentially with the same camera, and therefore the relevant parameters for a given image are estimated from that image only.

### Imaging and Range Map Generation

As β_{c}^{D} heavily depends on z, a range map of the scene is required, which may be obtained using, e.g., structure-from-motion (SFM), commonly used underwater to measure structural complexity of reefs and in archaeology. The present method requires an absolute value for z, whereas SFM provides range only up to scale, so objects of known sizes are placed in the scene (see FIGS. 3A-3B). When imaging from underwater vehicles, their navigation sensors can provide velocity or altitude. An alternative is stereo imaging, which requires the use of two synchronized cameras, and a straightforward in-water calibration before imaging survey begins. Additionally, methods for estimating range from monocular imaging can be used.

### Scene Reconstruction

From Eqs. 1 and 2 there can be obtained:

J_{c}=D_{c}e^{β}^{_{c}}^{^{D}}(z)z (8)

where D_{c}=I_{c}−B_{c}.

In one example, Eq 2 is solved where the z dependency of β_{c}^{D} is explicitly kept, but other dependencies are ignored. J_{c} is an image whose colors are only corrected along z, and depending on the imaging geometry, it may need further correction to achieve the colors of an image that was taken at sea surface. Let Jₛ denote the image taken at the surface. Then,

Jₛ=J_{c}/W_{c}, (9)

where W_{c} is the white point of the ambient light at the camera (i.e., at depth d), and Jₛ is J_{c} globally white balanced.

### Parameter Estimation

Backscatter increases exponentially with z, and eventually saturates (FIG. 2). Where scene reflectance ρ_{c}→0 (all light absorbed), or E→0 (complete shadow), the captured RGB intensity I_{c}→B_{c}.

In some embodiments, the present disclosure provides for searching the image for very dark or shadowed pixels, and using them to get an initial estimate of backscatter. This approach attempts to find the backscattered signal where the D_{c} is minimum, but differs from previous methods in utilizing a known range map rather than relying on an estimated range map.

In some embodiments, the present method searches for the darkest RGB triplets, rather than identifying the darkest pixels independently in each color channel, and thus not forming a dark channel image. The small number of unconnected pixels identified by the present method is sufficient in view of the available corresponding range information, and a physical model of how B_{c} behaves with z.

In some embodiments, backscatter may be estimated as follows: first the range map may be partitioned into evenly spaced clusters spanning the minimum and maximum values of z. In each range cluster, I_{c} is searched for the RGB triplets in the bottom 1 percentile, denoted by Ω. Then across the whole image, \hat{B}_{c}(Ω)≈I_{c}(Ω) is an overestimate of backscatter, which is modeled as:

\hat{B}_{c}=B_{c}^{∞}(1−e^{-β}^{_{c}}^{^{B}}^{z})+J_{c}′e^{-β}^{_{c}}^{^{D′}}^{z} (10)

where the expression J_{c}′e^{-β}^{_{c}}^{^{D′}}^{z} represents a small residual term that behaves like the direct signal.

Using non-linear least squares fitting, the parameters B_{c}^{∞}, β_{c}^{B}, J_{c′}, and β_{c}^{D′} are estimated subject to the bounds of, e.g., [0,1], [0,5], [0,1], and [0,5], respectively. For this step, the z-dependency of β_{c}^{D′} may be ignored. If information about the camera sensor, water type, etc., is available, the bounds for β_{c}^{D} and β_{c}^{B} may be further refined using a loci.

Depending on the scene, the residual can be left out of Eq. 10 if the reflectance of found dark pixels are perfect black; if they are under a shadow; if z is large; or if the water is extremely turbid (B_{c}>>D_{c}). In all other cases, the inclusion of the residual term is important. In reef scenes, due to their complex 3D structure, there are often many shadowed pixels which provide direct estimates of backscatter.

In some embodiments, backscatter estimation may be performed using additional and/or other methods, such as, but not limited to, histograms, statistical analyses, deep learning methods, and the like.

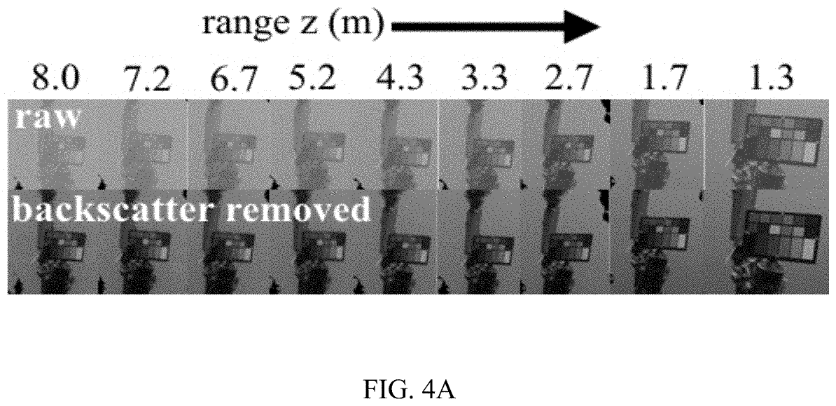

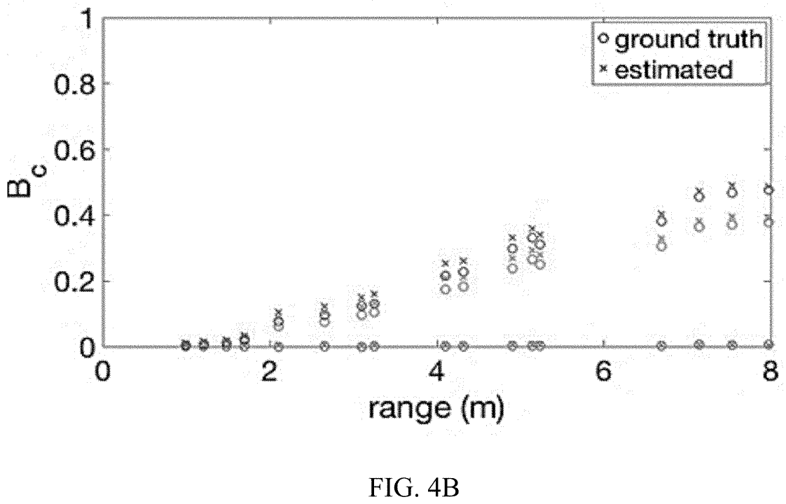

FIGS. 4A-4B demonstrate the performance of this method in a calibrated experiment.

FIG. 4A shows a color chart imaged underwater at various ranges. The top row in FIG. 4A shows the raw images I_{c}, and the bottom row shows the corresponding D_{c} backscatter-removed images.

FIG. 4B shows B_{c} calculation for each color channel according to the present method (x's), and the color-chart ground truth backscatter calculations (o's). As can be seen, the values are almost identical.

To acquire the images in FIG. 4A, a chart was mounted on a buoy line in blue water (to minimize interreflections from to the seafloor and surface), and photographed from increasingly reducing distances. The veiling effect of backscatter is clearly visible in the images acquired form farther away, and it is decreasing as z between the camera and the chart decreases (FIG. 4A).

For each image, the ground-truth backscatter is calculated using the achromatic patches of the chart, and also estimated using the present method. The results are presented in FIG. 4B. The resulting B_{c} values are almost identical; no inputs (e.g., water type) other than I_{c} and z were needed to obtain this result. Note that the black patch of the color chart was not picked up in Ω in any of the images, indicating that it is indeed a just dark gray and much lighter than true black or shadowed pixels.

It was previously shown that β_{c}^{D} varies most strongly with range z. Inspecting Eq. 3 suggests that this variation is in the form of an exponential decay. Accordingly, before extracting β_{c}^{D}(z) from images, the relationship between β_{c}^{D} and z must be formulated.

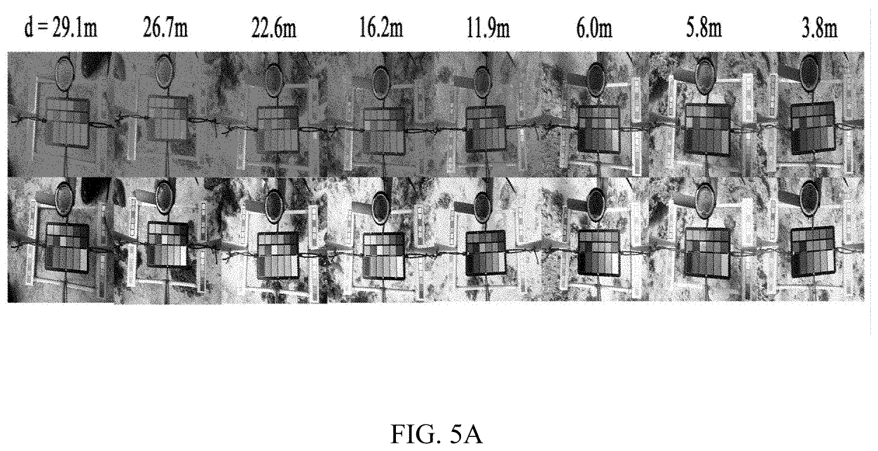

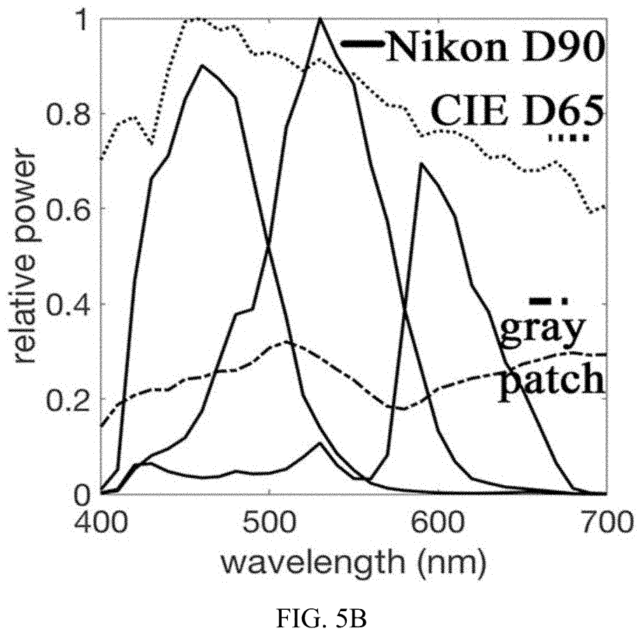

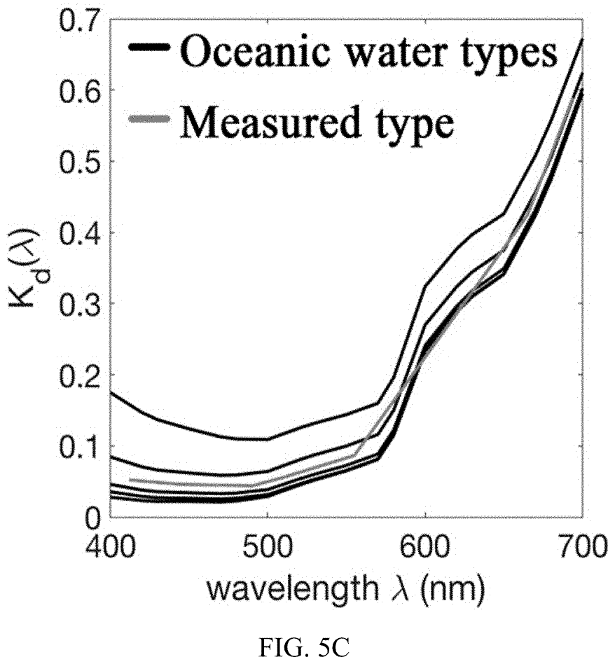

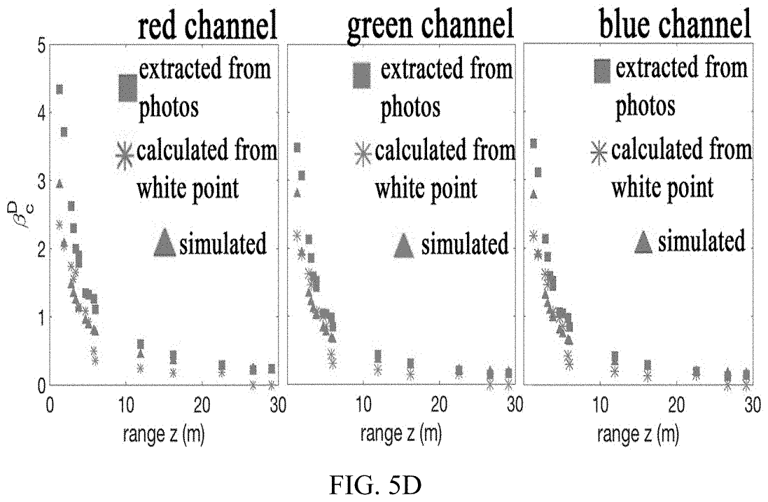

FIGS. 5A-5D show an experiment where a color chart and a Nikon D90 camera were mounted on a frame roughly 20 cm apart, and lowered in this configuration from surface level to a depth of 30 m underwater, while taking photographs. Backscatter and attenuation between the camera and the chart are both negligible, because the distance z between the chart and the camera is small, yielding I_{c}→J_{c}. In this setup, the color loss is due to the effective attenuation coefficient acting in the vertical distance d from the sea surface, and is captured in the white point of ambient light W_{c} at each depth.

FIG. 5A shows raw images captured by the camera (top row; not all are shown), and the same images after white balancing using the achromatic patch (bottom row). Brightness in each image was manually adjusted for visualization.

FIG. 5B shows a graph representing the value of β_{c}^{D}. The spectral response was obtained using a Nikon D90 camera assuming standard illuminant in accordance with CIE D65 light at the surface. The reflectance of the second brightest gray patch was measured, noting that it does not reflect uniformly. The diffuse downwelling attenuation coefficient K_{d}(λ) used for the optical water type was measured in situ.

FIG. 5C illustrates a measured water type curve which agrees well with the oceanic water types (black curves in the graph).

In FIG. 5D, β_{c}^{D} decays as a 2-term exponential with z as shown by all three methods. In some embodiments, additional and/or different parametrizations may be used.

From each image, the effective β_{c}^{D} was calculated in the vertical direction in two different ways: from pairwise images, and by using Eq. 9 with W_{c} extracted from the intensity of the second (24%) gray patch in the color chart. Additionally, Eq. 3 was used to calculate the theoretical value of β_{c}^{D} in the respective water type using the spectral response of the camera, and the measured K_{d}(λ) of the water body (which acts in the vertical direction). All three ways of estimating β_{c}^{D} in FIGS. 5A-5D demonstrate that β_{c}^{D} decays with distance, in this case d.

Based on the data in FIGS. 5A-5D and additional simulations, the dependency of β_{c}^{D} on any range z may be described using a 2-term exponential in the form of:

β_{c}^{D}(z)=a*exp(b*z)+c*exp(d*z) (11)

In some embodiments, additional and/or other parametrizations may be used, such as polynomials, a line model (for short ranges), or a 1-term exponential.

In some embodiments, an initial, coarse estimation of β_{c}^{D} (z) may be obtained from an image. Assuming B_{c} is successfully removed from image I_{c}, β_{c}^{D}(z) can be estimated from the direct signal D_{c}. Note from Eq. 2 that the direct signal is the product of the scene J_{c} (at the location of the camera) attenuated by e^{-β}^{_{c}}^{^{D}}^{(z)z}. Thus, the recovery of the scene J_{c} reduces to a problem of the estimation of the illumiant map between the camera and the scene, which varies spatially. Given an estimate of the local illuminant map Ê_{c}(z), an estimate of β_{c}^{D}(z) may be obtained as follows:

\hat{β}_{c}^{D}(z)=−log Ê_{c}(z)/z. (12)

Estimation of an illuminant locally is a well-studied topic in the field of computational color constancy. Several methods, most notably the Retinex model which mimics a human's ability to discount varying illuminations, have been applied on underwater imagery, and a recent work showed that there is a direct linear relationship between atmospheric image dehazing and Retinex. If backscatter is properly removed from original images, many of the multi-illuminant estimation methods may be expected to work well on underwater images.

In some embodiments, a variant of the local space average color (LSAC) method may be employed, as it utilizes a known range map. This method works as follows: for a given pixel (x,y) in color channel c, local space average color a_{c}(x,y) is estimated iteratively through updating the equations:

$$\begin{matrix}{a}_{{c}^{′}} ( x , y ) = \frac{1}{{N}_{e}} {\sum }_{{N}_{e}} {a}_{c} ( {x}^{′} , {y}^{′} ) & ( 13 ) \\ {a}_{c} ( x , y ) = {D}_{c} ( x , y ) p + {a}_{{c}^{′}} ( x , y ) ( 1 - p ) , & ( 14 )\end{matrix}$$

where the neighborhood Nₑ is defined as the 4-connected pixels neighboring the pixel at (x,y) which are closer to it than a range threshold E:

Nₑ(x′,y′)=(x′,y′) with∥z(x,y)−z(x′,y′)∥≤∈. (15)

Here, the initial value of a(x,y) is taken as zero for all pixels, since after a large number of iterations the starting value will be insignificant. The parameter p describes the local area of support over which the average is computed and depends on the size of the image; large p means that local space average color will be computed for a small neighborhood. Then, the local illuminant map is found as Ê_{c}=f a_{c}, where f is a factor based on geometry scaling all color channels equally and can be found based on the scene viewed. We use f=2 for a perpendicular orientation between the camera and the scene.

In some embodiments, the initial estimate of β_{c}^{D}(z) may be refined using the known range map z, corresponding to the given z in the image. Accordingly, in some embodiments, Eq. 12 may be re-written as:

\hat{z}=−log Ê_{c}/β_{c}^{D}(z) (16)

with a minimization:

$${min}_{{β}_{c}^{D} ( z )} ‖ z - \hat{z} ‖ \qquad ( 17 )$$

where β_{c}^{D}(z) is defined in the form of Eq. 11 with parameters a, b, c, d. The lower and upper bounds for these parameters to obtain a decaying exponential will be [0, −∞, 0, −∞], and [∞, 0, ∞, 0], respectively, but can be narrowed using the initial estimate obtained from Eq. 12.

In some embodiments, attenuation parameters estimation may be performed using additional and/or other methods, such as, but not limited to, histograms, statistical analyses, deep learning method, and the like.

In some embodiments, estimation of backscatter parameters and attenuation parameters may be performed as a single step analysis, using any one or more suitable statistical methods, and/or deep learning methods.

Using the estimated parameters, J_{c} may be recovered using Eq. 8.

In some embodiments, white balancing may be performed, before or after performing the steps of the present method. In J_{c}, spatial variation of ambient light has already been corrected, so all that remains is the estimation of the global white point W_{c}. This can be done using statistical or learning based methods. In some embodiments, for scenes that contain a sufficiently diverse set of colors, a method such as Gray World Hypothesis may be used, and for monochromatic scenes, a spatial-domain method that does not rely on color information may be used.

### Photofinishing

In some embodiments, a camera pipeline manipulation platform may be used to convert any outputs of the present method to a standard color space. In some embodiments, any other photofinishing methods can be applied.

### Datasets

Five underwater RGBD datasets were used for testing (see Table 1 below). All were acquired under natural illumination, in raw format, with constant exposure settings for a given set, and contain multiple images with color charts.

TABLE 1
Datasets used for testing with SFM-based range maps for each
image. Each set contains multiple images with a color chart.

| | | | | | | Water | | | |
|---|---|---|---|---|---|---|---|---|---|
| Set | Scene | Depth | | Angle | B_{c} | Type | # images | Camera | Lens |
| D1 | reef | 10 | m | down | low | clear | 559 | Sony α7R Mk | Sony FE 16-35 |
| | | | | | | | | III | mm f/2.8 GM |
| D2 | reef | 10 | m | down | high | clear | 318 | Sony α7R Mk | Sony FE 16-35 |
| | | | | | | | | III | mm f/2.8 GM |
| D3 | reef | 4 | m | all | low | clear | 68 | Sony α7R Mk | Sony FE 16-35 |
| | | | | | | | | III | mm f/2.8 GM |
| D4 | canyon | 4-9 | m | down | high | turbid | 153 | Nikon D810 | Nikkor 35 mm f1.8 |
| D5 | reef | 5 | m | forward | med | clear | 59 | Nikon D810 | Nikkor 35 mm f1.8 |

### Experimental Results

The present method was validated using the dataset detailed in Table 1 above and a stereo RGBD dataset. The present method was evaluated using the following scenarios:
(i) Scenario 1 (S1): Simple contrast stretch.
(ii) Scenario 2 (S2): Applying the DCP model with an incorrect estimate of B_{c} (e.g., because the model typically overestimates B_{c} in underwater scenes). For this purpose, the built-in imreducehaze function in MATLAB was used.
(iii) Scenario 3 (S3): Applying a known model with a correct estimate of B_{c} (i.e., correct B_{c}^{∞} and β_{c}^{B}), and assuming β_{c}=β_{c}^{D}=β_{c}^{B}.
(iv) Scenario 4 (S4): Applying a revised model, with a correct estimate of B_{c}, and J_{c} obtained as J_{c}=D_{c}/Ê_{c} without explicitly computing β_{c}^{D} (z).
(v) Scenario 5 (S5): The present method, which uses the revised model where β_{c}^{B}≠β_{c}^{D}, and β_{c}^{D}=β_{c}^{D}(z) from Eq. 11.

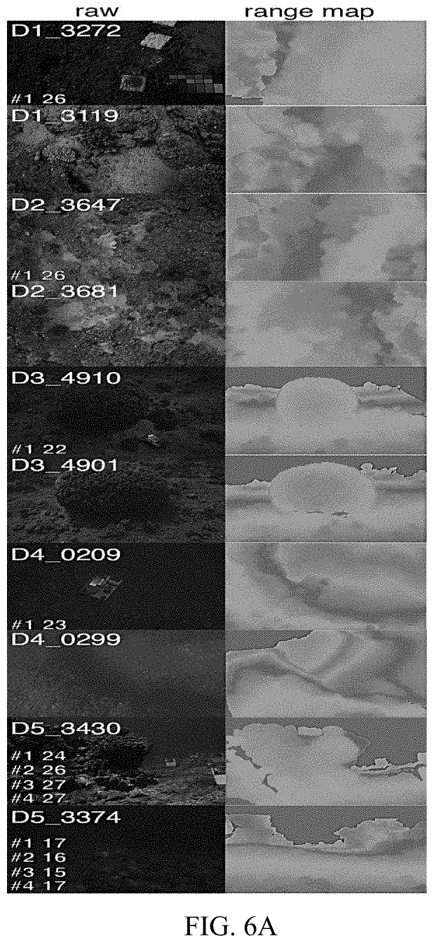

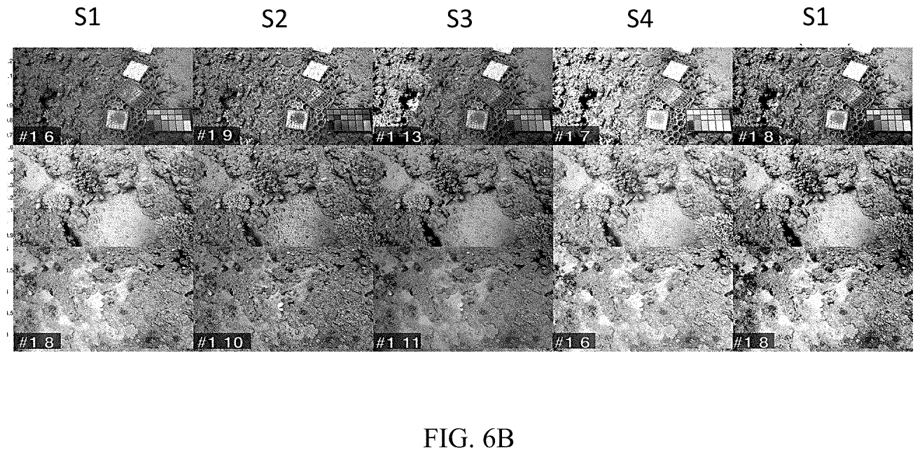

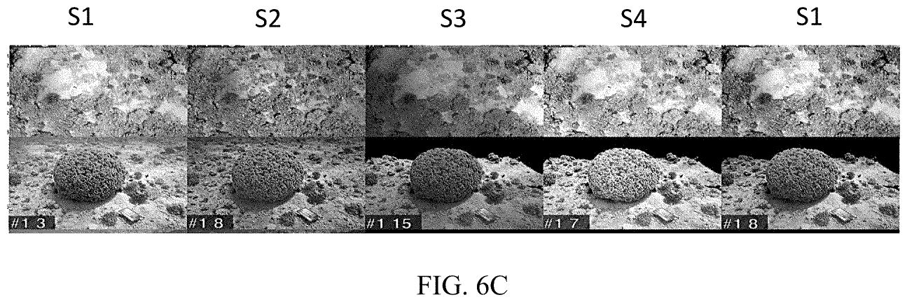

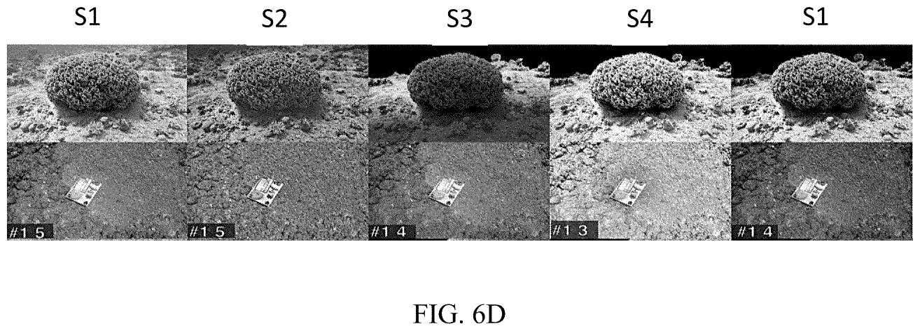

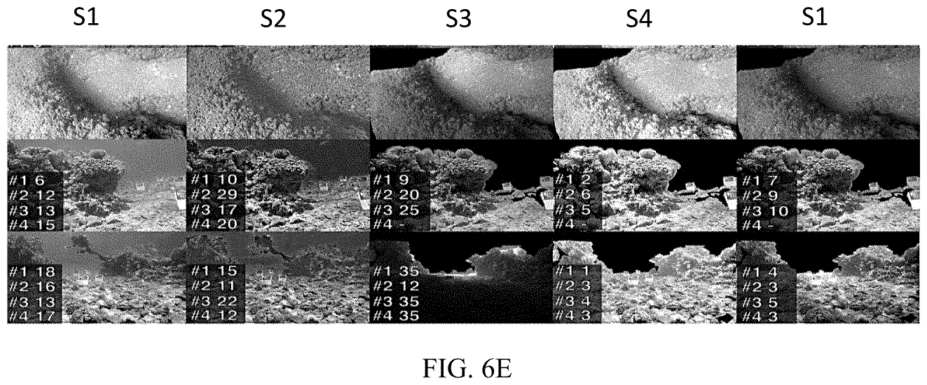

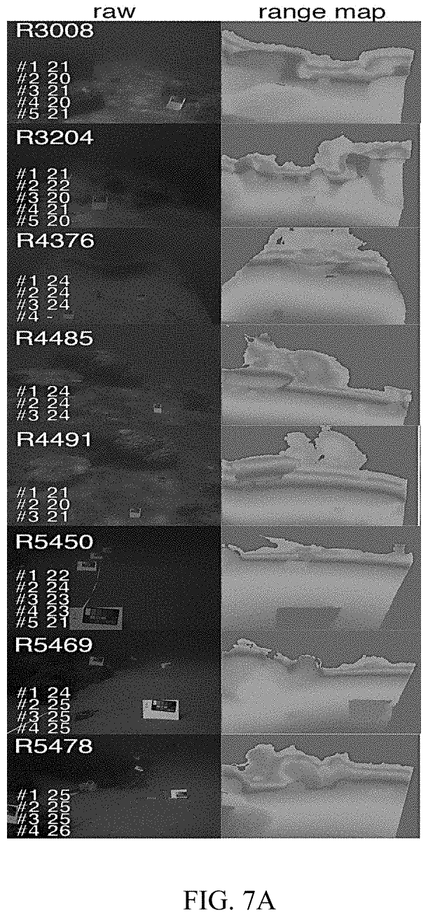

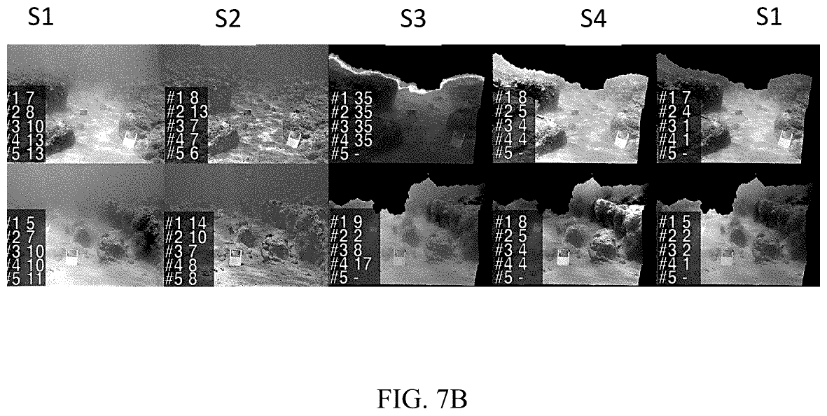

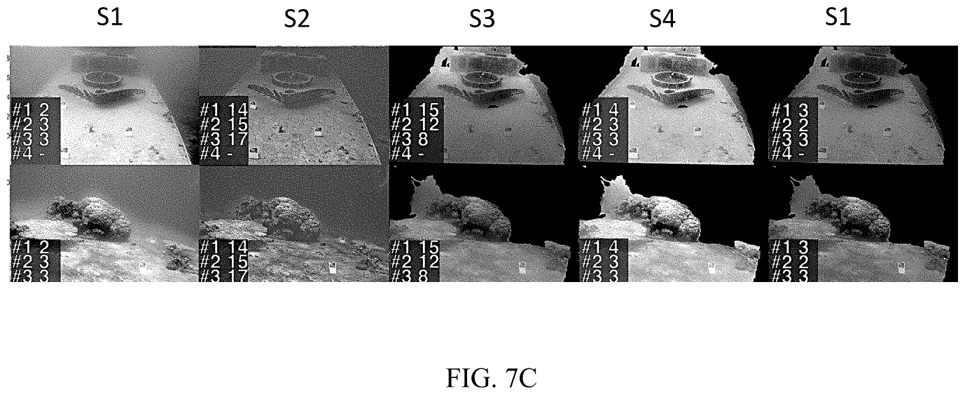

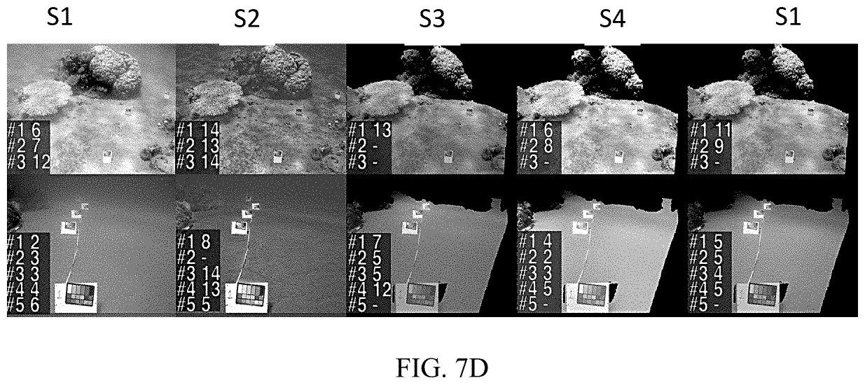

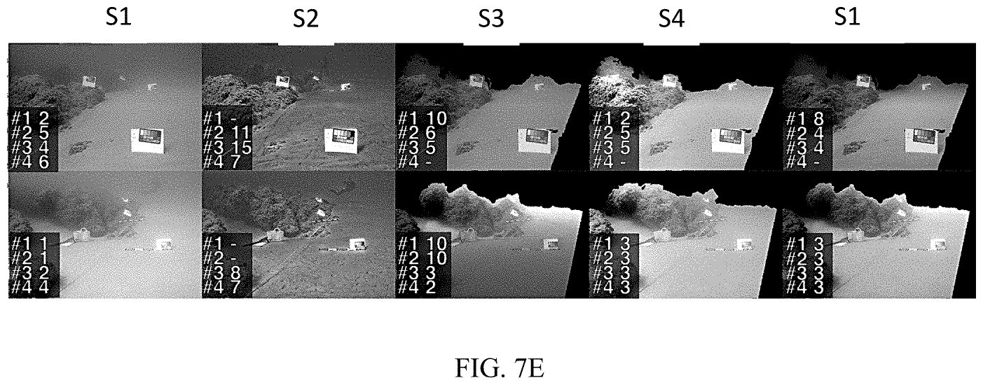

Because the present method is the first algorithm to use the revised underwater image formation model and has the advantage of having a range map, it was not tested against single image color reconstruction methods that also try to estimate the range/transmission. After a meticulous survey of these methods, it was found that DCP-based ones were not able to consistently correct colors, and others were designed to enhance images rather than achieve physically accurate corrections (see, e.g., D. Berman, D. Levy, S. Avidan, and T. Treibitz, “Underwater single image color restoration using haze-lines and a new quantitative dataset”, Arxiv, 2018). A previous proposed method was aimed to recover physically accurate colors (using the former model), but it only works for horizontal imaging with sufficiently large distances in the scene, making it unsuitable for many of our images. Raw images, range maps, and the corresponding S1-S5 results are presented in FIGS. 6A-6E (datasets 1-5 in Table 1), and on the stereo database (FIGS. 7A-7E). For evaluation, RGB angular error ψ̅ was used between the six grayscale patches of each chart and a pure gray color, averaged per chart:

ψ̅=(⅙)cos⁻¹[I_{c}/(\sqrt{3}∥I_{c}∥)] (18)

In FIGS. 6A-6E, for each chart and method, ψ̅ rounded to the nearest integer is given in inset; Chart #1 is closest to the camera. Average errors for the dataset are:

| Raw | Si | S2 | S3 | S4 | S5 (present) |
|---|---|---|---|---|---|
| 20.57 | 12.49 | 14.38 | 21.77 | 4.13 | 6.33 |

Reference is now made to FIGS. 7A-7E, which show results on the stereo dataset. Their range maps were further processed to remove spurious pixels. ψ̅ rounded to the nearest integer is given in inset; chart #1 is closest to the camera. S1 and S2 do not utilize range maps; for others, lack of ψ̅ values indicate missing range information. The average errors across all images are:

| Raw | Si | S2 | S3 | S4 | S5 (present) |
|---|---|---|---|---|---|
| 22.28 | 6.83 | 10.03 | 12.04 | 4.46 | 4.94 |

Lower ψ̅ value indicates better correction (though see exceptions below); errors (in degrees) are listed in the insets of FIGS. 6A-6E and 7A-7E per color chart for scenes that had them, rounded to the nearest integer.

In all cases, the simple contrast stretch S1, which is global, works well when scene distances are more or less uniform. The DCP method (S2) often overestimates backscatter (which can improve visibility), and generally distorts and halucinates colors. For example what should be uniformly colored sand appears green and purple in both datasets.

In D1_3272, the gray patches of the color chart in S2 have visible purple artifacts, yet their ψ̅ error is lower than that of S5, suggesting that ψ̅ is not an optimal metric for quantifying color reconstruction error. In S3-S5, the correct amount of B_{c} is subtracted. In S3 attenuation is corrected with a constant β_{c}^{D}, as had been done by methods using the former model.

When there is large variation in range (e.g., FIG. 7), the failure of the constant β_{c}^{D} assumption is most evident, and this is also where S5 has the biggest advantage (though S3 also fails on scenes with short ranges, e.g., D3 and D4). Range maps often tend to be least accurate furthest from the camera, which also adds to the difficulty of reconstructing colors at far ranges. S4 sometimes yields lower errors on the color cards than S5. This makes sense as it is easier to calculate the illuminant on the cards; however S5 results are better on the complete scenes. S4 can be used for a first-order correction that is better than previous methods.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of modified purpose computer, special purpose computer, a general computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
at least one hardware processor; and
a non-transitory computer-readable storage medium having stored thereon program instructions, the program instructions executable by the at least one hardware processor to:
receive an input image, wherein the input image depicts a scene within a medium which has wavelength-dependent absorption and/or scattering,
estimate, based, at least in part, on a range map of said scene, one or more image formation model parameters, and
recover said scene from said input image, based, at least in part, on said estimating.

2. The system of claim 1, wherein said image is selected from the group consisting of grayscale image, RGB image, RGB-Depth (RGBD) image, multi-spectral image, and hyperspectral image.

3. The system of claim 1, wherein said medium is one of: water and ambient atmosphere.

4. The system of claim 3, wherein said scene is under water.

5. The system of claim 1, wherein said recovering removes an effect of said wavelength-dependent absorption and/or scattering medium from said input image.

6. The system of claim 1, wherein said image formation model parameters include at least one of: backscatter parameters in said input image, and attenuation parameters in said input image.

7. The system of claim 1, wherein said image formation model parameters are estimated separately with respect to each color channel in said input image.

8. The system of claim 1, wherein said estimating of said one or more image formation model parameters is based, at least in part, on distances to each object in said scene, wherein said distances are obtained using said range map.

9. The system of claim 1, wherein said range map is obtained using one of: a structure-from-motion (SFM) range imaging techniques, stereo imaging techniques, and monocular techniques.

10. A method comprising:
receiving an input image, wherein the input image depicts a scene within a medium which has wavelength-dependent absorption and/or scattering;
estimating, based, at least in part, on a range map of said scene, one or more image formation model parameters; and
recovering said scene from said input image, based, at least in part, on said estimating.

11. The method of claim 10, wherein said image is selected from the group consisting of grayscale image, RGB image, RGB-Depth (RGBD) image, multi-spectral image, and hyperspectral image.

12. The method of claim 10, wherein said medium is one of: water and ambient atmosphere.

13. The method of claim 12, wherein said scene is under water.

14. The method of claim 10, wherein said recovering removes an effect of said wavelength-dependent absorption and/or scattering medium from said input image.

15. The method of claim 10, wherein said image formation model parameters include at least one of: backscatter parameters in said input image, and attenuation parameters in said input image.

16. The method of claim 10, wherein said image formation model parameters are estimated separately with respect to each color channel in said input image.

17. The method of claim 10, wherein said estimating of said one or more image formation model parameters is based, at least in part, on distances to each object in said scene, wherein said distances are obtained using said range map.

18. The method of claim 10, wherein said range map is obtained using one of: a structure-from-motion (SFM) range imaging techniques, stereo imaging techniques, and monocular techniques.

19.-27. (canceled)
